(19) United States
(12) Patent Application Publication
(10) Pub. No.: US 2022/0043883 A1
(43) Pub. Date: Feb. 10, 2022

(54) HARDWARE IMPLEMENTATION OF DISCRETE FOURIER TRANSFORM

(71) Applicant: ARRIS Enterprises LLC, Suwanee, GA (US)

(72) Inventors: Janusz Biegaj, Hinsdale, IL (US); Sherri Neal, Aurora, IL (US); Tennyson M. Mathew, Lisle, IL (US); Xiaofei Dong, Naperville, IL (US)

(21) Appl. No.: 17/398,625

(22) Filed: Aug. 10, 2021

Related U.S. Application Data
(60) Provisional application No. 63/063,720, filed on Aug. 10, 2020.

(51) Int. Cl. G06F 17/14

(52) U.S. Cl. CPC G06F 17/142

(57) ABSTRACT

Improved devices and methods for performing Fast Fourier Transforms.

### CROSS REFERENCE TO RELATED APPLICATIONS

This application claims the benefit of the U.S. Provisional Application Ser. No. 63/063,720 filed Aug. 10, 2020.

### BACKGROUND

The subject matter of this application relates to devices and methods for performing a Discrete Fourier Transform, and more particularly, a Fast Fourier Transform.

In modern digital systems, the Discrete Fourier Transform (DFT) is used in a variety of applications. In cable communications systems, for example, Orthogonal Frequency Division Multiplexing (OFDM), the essence of which is DFT, is used to achieve spectrum-efficient data transmission and modulation. In wireless communications technologies, DFT-based OFDM has been widely adopted in 4G LTE and 5G cellular communications systems. Furthermore, in medical imaging the two-dimensional DFT has been used for decades in Magnetic Resonance Imaging (MRI), to map a test subject's internal organs and tissues, and in the test equipment realm, a DFT is used to provide fast and accurate spectrum analysis.

A DFT is obtained by decomposing a sequence of values into components of different frequencies, and although its use extends to many fields as indicated above, its calculation is usually too intensive to be practical. To that end, many different Fast Fourier Transforms (FFT) have been mathematically formulated that calculate a DFT much more efficiently. An FFT rapidly computes such transformations by factorizing the DFT matrix into a product of smaller factors. As a result, it manages to reduce the complexity of computing the DFT from an exponential function of data size to a logarithmic function of data size. The difference in speed and cost can be enormous, especially for long data sets where N may be in the thousands or millions. Furthermore, in the presence of round-off error, many FFT algorithms are much more accurate than evaluating the DFT definition directly or indirectly.

In order to meet high performance and real-time requirements of modern applications, engineers have tried to implement efficient hardware architectures that compute the FFT. In this context, parallel and/or pipelined hardware architectures have been used because they provide high throughputs and low latencies suitable for real-time applications. These high-performance requirements appear in applications such as Orthogonal Frequency Division Multiplexing (OFDM) and Ultra-Wideband (UWB). In addition, high-throughput resource efficient implementation of FFT, and its reciprocal Inverse FFT (IFFT), is required in Field Programmable Gate Arrays (FPGA) and Application-Specific Integrated Circuits (ASIC), where On-chip resources such as hard multipliers and memory, must be used as efficiently as possible.

What is desired, therefore, are improved systems and methods that provide an efficient and flexible hardware implementation of an FFT.

### BRIEF DESCRIPTION OF THE DRAWINGS

For a better understanding of the invention, and to show how the same may be carried into effect, reference will now be made, by way of example, to the accompanying drawings, in which:

FIG. 1 shows a multiple-stage implementation of a Fast Fourier Transform.

FIG. 2 shows an exemplary hardware implementation of stage-p of the implementation of FIG. 1, in an embodiment with a single radix-p engine.

FIG. 3 shows an alternate exemplary hardware implementation of stage-p of the implementation of FIG. 1, in an embodiment with a single radix-p engine.

FIG. 4 shows an exemplary hardware implementation of stage-p of the implementation of FIG. 1, in an embodiment with multiple radix-p engines.

FIG. 5 shows an alternate exemplary hardware implementation of stage-p of the implementation of FIG. 1, in an embodiment with multiple radix-p engines

FIG. 6 shows a cyclic prefix in OFDM (de)modulation.

### DETAILED DESCRIPTION

Disclosed in the present specification is a novel, versatile, high-throughput hardware architecture for efficiently computing an FFT that allows different resources to be used, depending on the needs of a particular application. As an example, a designer may wish to optimize memory usage over performance in one application, whereas another application may benefit from the opposite. As another example, different variations of the disclosed architecture may be optimized for memory restricted systems, or multiplier restricted systems (i.e., hard DSP on FPGA). In preferred embodiments, the disclosed systems and methods can be used for arbitrary FFT sizes, and not limited to power of 2 numbers.

An N-point DFT is defined as

$$X ( k ) = {\sum }_{n = 0}^{N - 1} x ( n ) {e}^{- j \frac{2 π n k}{N}} = {\sum }_{n = 0}^{N - 1} x ( n ) {W}_{N}^{n k} \qquad ( 1 )$$

with kϵ[0, N−1], and W_{N}=e^{-j2π/N}. The inverse DFT is the reciprocal of the DFT, and defined as

$$x ( n ) = \frac{1}{N} {\sum }_{k = 0}^{N - 1} X ( k ) {e}^{j \frac{2 π n k}{N}} \qquad ( 2 )$$

with nϵ[0, N−1].

The DFT size N can be transformed into smaller integers, N=ΠₗNₗ, which turns the input and output indices of the DFT sequence into multi-dimensional arrays. These DFT algorithms are referred to as FFTs, and the most universal FFT is the Cooley-Tukey algorithm. In the Cooley-Tukey algorithm the DFT size N can be factored into arbitrary integers. For example, suppose N can be written as N=N1N2, where N1 and N2 are integers and not necessarily coprime. The input index n becomes

$$n = {N}_{2} {n}_{1} + {n}_{2} \{ \begin{matrix}0 \leq {n}_{1} \leq {N}_{1} - 1 \\ 0 \leq {n}_{2} \leq {N}_{2} - 1\end{matrix} \qquad ( 3 )$$

and the output index k becomes

$$k = {k}_{1} + {N}_{1} {k}_{2} \{ \begin{matrix}0 \leq {k}_{1} \leq {N}_{1} - 1 \\ 0 \leq {k}_{2} \leq {N}_{2} - 1 \end{matrix} \qquad ( 4 )$$

The N-point FFT can be rewritten using the index mapping as

X(k₁+N₁k₂)=Σₙ₌₀^{N-1}×(n)W_{N}^{nk}=Σₙ_{₂}₌₀^{N}^{₂}⁻¹Σₙ_{₁}₌₀^{N}^{₁}⁻¹×(N₂n₁+n₂)W_{N}_{₁}ⁿ^{₁}^{k}^{₁}W_{N}ⁿ^{₂}^{k}^{₁}W_{N}_{₂}ⁿ^{₂}^{k}^{₂}. (5)

The transformed format in Equation (5) implies that the original FFT can be implemented in two stages: first an N₁ point FFT processes all input data in sections, then the output of the N₁-FFT is multiplied with a twiddle factor, the output of which is processed by the second stage N₂ point FFT. This process can be carried out iteratively when N is factored into the product of multiple integers. Suppose N is factored L times, with N=Πₗ₌₁^{L} Nₗ. The input index n can be rewritten as an array of smaller indices n₁, n₂, . . . n_{L}, with

$$n = {N}_{L} ( {N}_{L - 1} ( {N}_{L - 2} ( … ( {N}_{3} ( {N}_{2} {n}_{1} + {n}_{2} ) + {n}_{3} ) … + {n}_{L - 2} ) + {n}_{L - 1} ) + {n}_{L} \\ where \\ \{ \begin{matrix}0 \leq {n}_{1} \leq {N}_{1} - 1 \\ 0 \leq {n}_{2} \leq {N}_{2} - 1 \\ … \\ 0 \leq {n}_{L} \leq {N}_{L} - 1\end{matrix} \qquad ( 6 )$$

The output index k is rewritten as an array of smaller indices k₁, k₂, . . . k_{L} with

$$k = {k}_{1} + {N}_{1} ( {k}_{2} + {N}_{2} ( {k}_{3} + {N}_{3} ( … ( {k}_{L - 2} + {N}_{L - 2} ( {k}_{L - 1} + {N}_{L - 1} {k}_{L} ) … ) ) ) \\ where \\ \{ \begin{matrix}0 \leq {k}_{1} \leq {N}_{1} - 1 \\ 0 \leq {k}_{2} \leq {N}_{2} - 1 \\ … \\ 0 \leq {k}_{L} \leq {N}_{L} - 1\end{matrix} \qquad ( 7 )$$

The N-point FFT can be derived by iteratively calculating N₁-point FFT, multiplied by twiddle factors, for 1=1, 2, . . . L−1, and the last stage is the N_{L}—point FFT. The L stages of calculation follow a similar structure:

$$X ( {k}_{1} + {N}_{1} {k}_{2} + {N}_{1} {N}_{2} {k}_{3} + … + {N}_{1} {N}_{2} {N}_{3} … {N}_{L - 1} {k}_{L} ) = {\sum }_{n = 0}^{N - 1} x ( n ) {W}_{N}^{n k} = {\sum }_{{n}_{L} = 0}^{{N}_{L} - 1} … {\sum }_{{n}_{p} = 0}^{{N}_{p} - 1} … {\sum }_{{n}_{2} = 0}^{{N}_{2} - 1} {\sum }_{{n}_{1} = 0}^{{N}_{1} - 1} x ( {N}_{L} {N}_{L - 1} … {N}_{3} {N}_{2} {n}_{1} + {N}_{L} {N}_{L - 1} … {N}_{4} {N}_{3} {n}_{2} + … + {N}_{L} {N}_{L - 1} … {N}_{p + 2} {N}_{p + 1} {n}_{p} + … + {N}_{L} {N}_{L - 1} {n}_{L - 2} + {N}_{L} {n}_{L - 1} + {n}_{L} ) {W}_{{N}_{1}}^{{n}_{1} {k}_{1}} {W}_{{N}_{1} {N}_{2}}^{{n}_{2} {k}_{1}} {W}_{{N}_{2}}^{{n}_{2} {k}_{2}} {W}_{{N}_{1} {N}_{2} {N}_{3}}^{{n}_{3} ( {k}_{1} + {N}_{1} {k}_{2} )} {W}_{{N}_{3}}^{{n}_{3} {k}_{3}} … \\ {W}_{{N}_{1} {N}_{2} . . {N}_{p}}^{{n}_{p} ( {k}_{1} + {N}_{1} {k}_{2} + … + {N}_{1} {N}_{2} … {N}_{p - 2} {k}_{p - 1} )} {W}_{{N}_{p}}^{{n}_{p} {k}_{p}} … {W}_{{N}_{1} {N}_{2} … {N}_{L}}^{{n}_{L} ( {k}_{1} + {N}_{1} {k}_{2} + … + {N}_{1} {N}_{2} … {N}_{L - 2} {k}_{L - 1} )} {W}_{{N}_{L}}^{{n}_{L} {k}_{L}} \qquad ( 8 )$$

In this decomposition, we observe that the first step in calculating the original N-point FFT, is to calculate N₁-point FFT, illustrated by the weights W_{N}_{₁}ⁿ^{₁}^{k}^{₁}. The results are multiplied by complex coefficients we call twiddle factors, shown in Equation (8) as those coefficients having superscripts/subscripts with different index values, e.g. W_{N}_{₁}_{N}_{₂}ⁿ^{₂}^{k}^{₁}. The next step is to calculate N₂-point FFT, and it goes on. The twiddle factors of each stage vary.

Hardware efficient implementation of the above iterative FFT structure typically chooses integer decomposition N₁ to N_{L} as small integers. For example, N=12 point FFT can be implemented as a cascade of radix-4 FFT and radix-3 FFT. Alternatively, the radix-4 FFT can be further decomposed to a cascade of two radix-2 FFT.

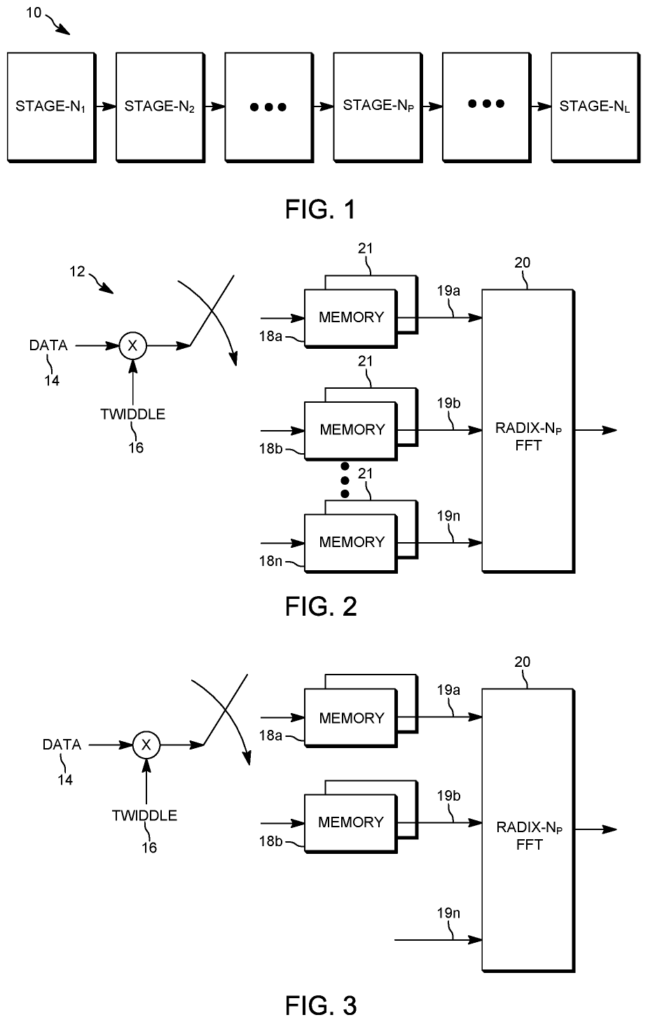

FIG. 1 shows a general architecture 10 of an efficient and flexible hardware implementation for calculating a Fast Fourier Transform via a plurality of stages N₁ to N_{L}. FIG. 2 shows a block diagram of a hardware implementation 12 for stage N_{P} of the architecture of FIG. 1 using a single radix-p engine 20. Broadly, in each stage of the calculation, the implementation 12 multiplies complex sequential data 14 with twiddle factors 16 (with the exception of the first stage, which does not need to be pre-multiplied with twiddle factors), and stores the product in memory blocks 18a to 18n, where there are Np blocks of memory. Each data storage block 18a to 18n is Πₗ₌₁^{p-1} Nₗ words deep, i.e., the memory depth is the product of all radix sizes of previous stages. Thus, for example, the storage blocks 18a to 18n of FIG. 2 would be capable of storing all the data inside the summation Σₙ_{ₚ}₌₀^{N}^{ₚ}⁻¹ . . . of Equation 8.

Data fills the memory blocks sequentially. After the first Πₗ₌₁^{p-1} Nₗ words fill up the first memory block, the next Πₗ₌₁^{p-1} Nₗ words are written sequentially into the second memory block, and so on. Once the top Nₚ₋₁ memory blocks are filled, data is ready to be read out simultaneously from all memory blocks for radix-Nₚ FFT calculation. Nₚ parallel inputs 19a to 19n to the radix engine in FIG. 2 allow a new output every clock cycle, and the result feeds the input of the next stage Nₚ₊₁ FFT processing, where the memory blocks of the next stage Nₚ₊₁ have enough memory to store all the data in the summation Σₙ_{ₚ₊₁}₌₀^{N}^{ₚ₊₁}⁻¹ . . . and so forth.

When all the memory blocks are filled with new data, time is needed to read the data for the radix-Nₚ FFT calculation, during which new data needs to be written to memory. Thus, shadow memory blocks 21 of the same depth for each memory block may preferably be used to store the incoming data. Once all data in the first set of memory blocks 18a to 18n are all read out for processing, the memory read operation switches to the shadow memory blocks 21.

For stage-p of this architecture, 2Πₗ₌₁^{p} Nₗ words are stored in memory blocks. Nₚ₋₁ complex multiplication is needed since W₀ is trivial and is a direct pass-through. The total memory usage of all N_{L} stages using the architecture of FIG. 2, is 2(N₁+N₁N₂+N₁N₂N₃+ . . . +N₁N₂ . . . N_{L}). Σₚ₌₁^{L} Nₚ−L total complex multiplication is need. Data within each radix Np engine does not need to be reordered, and data between stages does not need to be reordered, thus control logic for FIG. 2 can be very simple.

Notably, the last memory block 18a shown in FIG. 2 including its associated shadow memory 21 can be eliminated, since the radix-p calculation by engine 20 can start once data begins to be written to this last block. Therefore, the structure in FIG. can be modified to have only Np−1 blocks of memory, with a minimum increase in control logic. This memory efficient modification is shown in FIG. 3. The total memory usage for the entire FFT using the memory efficient variation of FIG. 3 is reduced to 2(N₁N₂ . . . N_{L}−1N_{L}−N₁)

In the special case where the FFT size is a power of 2, the most commonly-used factorization of N is 4 or 2, or a combination of these two numbers, since radix-2 and radix-4 calculations do not need any complex multiplication. The most commonly discussed FFT architectures in literature have focused on power of 2 FFT sizes. When N is a power of 4, and radix-4 engines are used for each stage, the architecture in FIG. 2 uses 4p words-worth of memory in the p-stage engine. The single radix-4 engine does not use any multiplication steps, but uses eight addition/subtraction steps. The twiddle multiplication is a single complex multiplication, and requires four real multiplications and two additions. Memory usually is needed to store twiddle factors, or it can be generated real-time using CORDIC based algorithms. The entire FFT calculation of L radix-4 stages will consume 8/3(N−1) words worth of memory to store data, log₄ N−1 complex multiplications (used in twiddle multiplication), and 3 log₄ N complex additions. The memory efficient variation in FIG. 3 will need 2(N−1) words worth of memory for data storage. If all stages use radix-2 engines, memory usage for FIG. 2 becomes 4(N−1) and for FIG. 3 becomes 2(N−1).

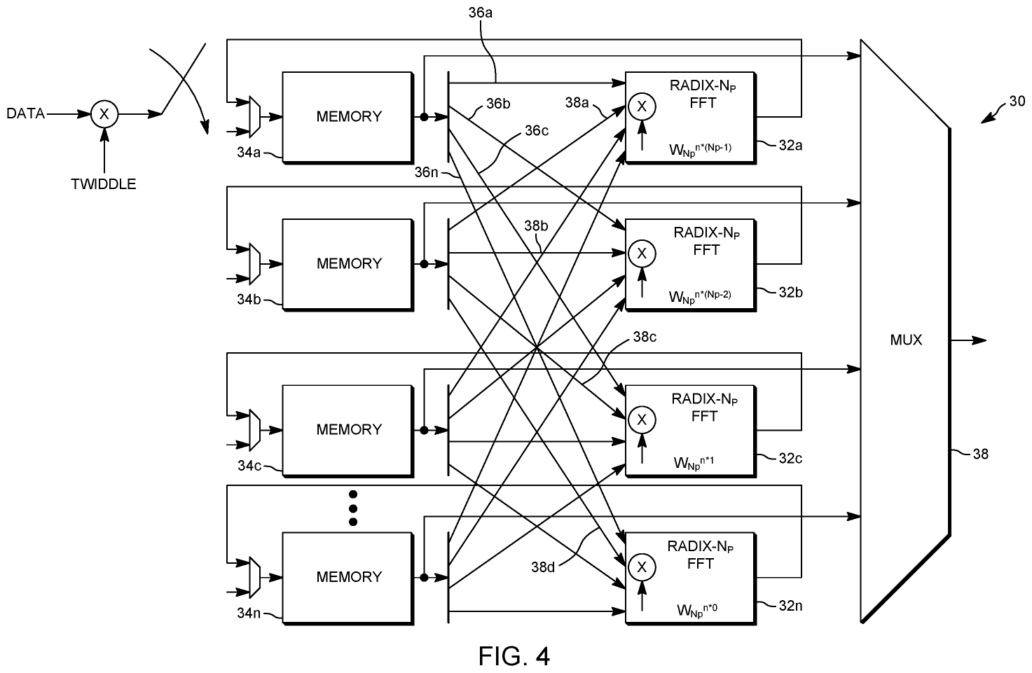

When the FFT size is large, the shadow memory of the above structure still consumes significant amount of memory. A memory-efficient alternative system 30 is shown in FIG. 4. Instead of having a single radix-p FFT engine, the embodiment of FIG. 4 uses “p” instances 32a to 32n of the radix-p engine. During the radix calculation phase, the output of each of memory block 34a to 34n is input to every radix-p engine 32a to 32n via engine inputs 36a to 36p, 38a to 38p, and so forth. In a single clock cycle, all the p-point FFT outputs are generated. The output of each radix-p FFT engine, is fed back to memory blocks 34a to 34n for temporary storage. One can then control the memory read to propagate the stored FFT outputs in a particular sequence of choice.

Using the system 30, the calculated p-point FFT outputs take up the slots in memories that stored input samples used for the current calculation, that is, an in-place swap of memory contents. This concept is illustrated in FIG. 4. Like FIG. 2, when the first location of the last block memory 34n is filled with new data, enough data samples are available for FFT calculation, and the module enters the radix calculation phase. Because there are p-parallel engines, all p FFT outputs are generated in a single clock cycle. Note the output index of the p FFT engines are Πₗ₌₁^{p-1} Nₗ apart. For instance, the first batch of outputs of FIG. 4 corresponds to output index 0, Πₗ₌₁^{p-1} Nₗ, 2Πₗ₌₁^{p-1} Nₗ, . . . (Nₗ−1)Πₗ₌₁^{p-1} Nₗ, from radix engines 32n, 32c, 32b and 32a outputs respectively. They are stored in the first location of each of the p block memories. For example, 32c output can be stored back in the first location of 34c. Note that the source data samples in those locations only need to be read once, and they become obsolete after the first output data becomes available. Therefore, there is no data loss in terms of input or output in this in-memory swap operation. The next clock cycle, the read pointers of the block memories shift down uniformly, a new set of input samples pass on to the radix engines, and a new batch of FFT outputs are generated, corresponding to output index 1, 1+Πₗ₌₁^{p-1} Nₗ, 1+2Πₗ₌₁^{p-1} Nₗ, . . . 1+(Nₗ−1) Πₗ₌₁^{p-1} Nₗ. Index 1 output data from 32n can be stored back in 34n, and output index 1+Πₗ₌₁^{p-1} Nₗ from 32c is stored back in 34c etc. This operation continues until Πₗ₌₁^{p-1} Nₗ cycles later. At this point, all source data in block memories have been used and replaced by calculated FFT outputs. The system switches from radix calculation phase to the output phase. As stored FFT output are read from block memories and passed to output Mux sequentially, while new input data for the next FFT frame are written into memory, filling up the space the old FFT outputs used to be.

With this operation, one can choose the output sequence to be in natural order, or bit reversed order, or any other uncommon order. If cyclic prefix is required as in modern OFDM communications, and the architecture in FIG. 4 is used for the last stage of the overall FFT calculation, one can take advantage of the flexibility of the structure and pass output from any index. Additional memory is needed to store the cyclic prefix section, which usually is a small section (commonly no more than ¼ of the entire FFT frame or symbol). This is a significant saving of memory compared with known structures where usually an entire FFT frame needs to be buffered for bit reversal and/or cyclic prefix.

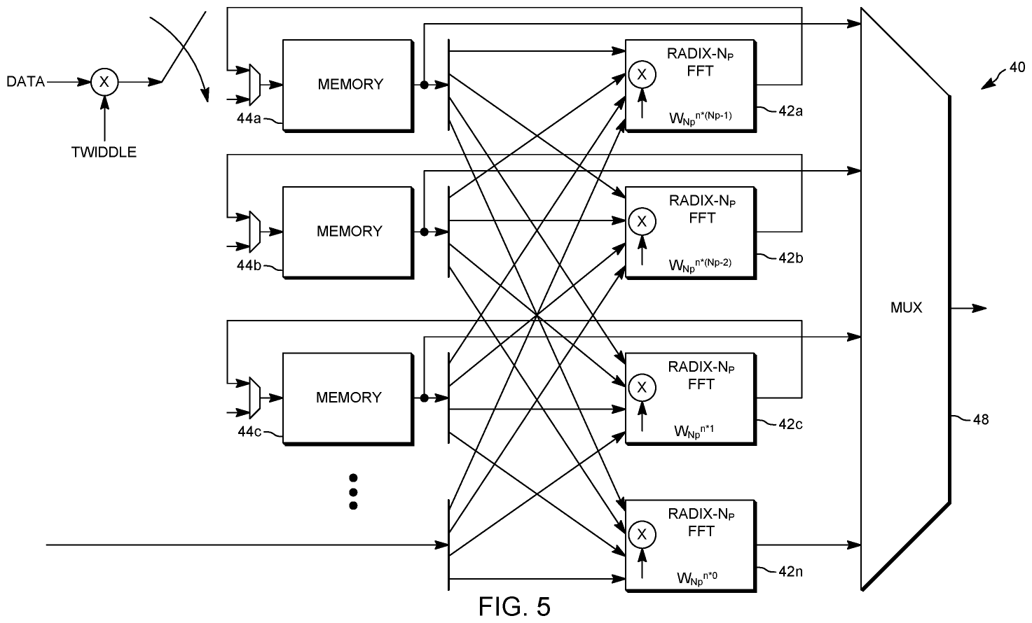

The control for the parallel engine structure is a bit more complex than the single engine case, as one needs to time the operation of memory read and write from the input and from the radix-p engine outputs. Those of ordinary skill in the art will appreciate that the parallel engines only need to be active for 1/p of the time since input data to the engines come in parallel one clock cycle at a time. However, depending on FFT size and which stage it is used, the memory savings may be significant. Furthermore, as with the single engine case shown in FIG. 3, FIG. 4 can be further improved for memory usage to use only p−1 memory blocks when output data is in natural order. The most memory efficient per stage architecture is shown in FIG. 5.

A close examination of FIG. 4 reveals that the stored FFT outputs in 34n are in natural order, with index 0, 1, . . . , Nₚ₋₁. For the most common use scenarios, FFT stages output data in natural order, which means radix engine 32n output can go directly to the output mux, instead of being written back to the memory. This is the illustrated in the system 40 of FIG. 5. The cycle after the input samples fill up block memory 44c, the system 40 enters radix calculation stage and output stage, with radix engine 42n output going directly to mux 48, while other radix engines 42c, 42b, 42a etc store their outputs back in block memories 44c, 44b, and 44a, respectively. After Πₗ₌₁^{p-1} Nₗ cycles, output mux switches from taking output of radix engine 42n to taking outputs of stored FFT in block memories, while new input samples can be accepted into block memories as well.

In the case of using all radix-4 decomposition, the total memory usage for calculating the N-point FFT is 4/3(N−1) words using the multiple engine but single memory block architecture of FIG. 4. If all stages use radix-2 engines, FIG. 4 based architecture would use 2(N−1) memory words. The architecture in FIG. 5 reduces total memory usage to (N−1) in both radix 4 and radix 2 decompositions, with tog, N−1 complex multiplications and 8 log₄N complex additions.

The input data sequence in the proposed FFT architecture naturally follows a bit-reversed pattern if the FFT size is a power of 2. The output may be in natural order or any other order.

One advantage of the architectures previously described is that it is possible to freely combine elements of the architectures shown in FIGS. 3 to 5, respectively, for different stages of the FFT calculation, and balance the multiplier and memory restriction on the FPGA. For example, in the first few stages of the FFT calculation, the memory depth for each block memory (which is the product of all previous radices) is small, and it may often be more economical to use a single engine architecture of FIG. 2 or FIG. 3, and save the hard multipliers on the FPGAs. This is especially true if the first few radices are not power of 2 numbers, such as 3, 5, 7 or other prime numbers. Every prime number radix calculation needs multiplications, unlike radix 2 and radix 4 where multiplication is replaced by additional and subtraction. In the last few stages of an FFT calculation, each block memory becomes deeper, and depending on the whole system being implemented, it may be more economical to use the architecture(s) shown in FIG. 4 and/or FIG. 5 to save memory, at the expense of the multipliers. However, one can also choose to use the architectures of FIG. 4 and/or FIG. 5 for radix4 and radix2 if possible, and the multiplier issue is significantly alleviated compared to using these architectures on a non-2 prime number radix. Thus, the disclosed architectures enable a large degree of freedom to optimize over different criterions, locally or globally.

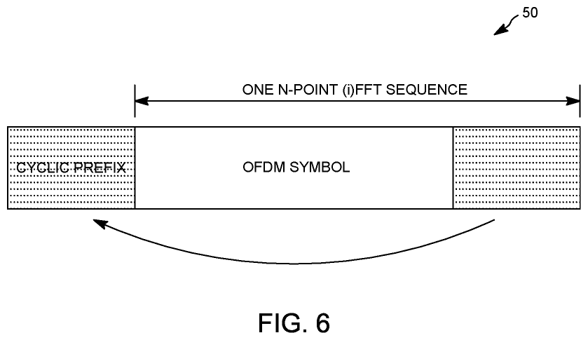

Furthermore, the proposed architectures, such as that disclosed in FIG. 4, is particularly advantageous in implementing an FFT for OFDM modulation in wireless and cable communications. In OFDM systems, after an FFT is calculated, a section of the end of the FFT output is duplicated and attached to the beginning of the FFT sequence. This redundant partial data is called cyclic prefix and it helps prevent inter symbol interference. FIG. 6 illustrates a cyclic prefix in OFDM modulation.

The length of the cyclic prefix is typically reconfigurable based on system performance and channel conditions. Conventional FFT architectures require the entire FFT frame to be buffered for cyclic prefix insertion. If an FFT engine generates outputs in a bit reversed order, double buffer of size 2N is needed for both bit reversal and cyclic prefix insertion. The proposed architecture of FIGS. 4 and 5 allow sequential FFT outputs to be read out anywhere within the FFT frame, without additional buffering. FFT radix-N_{L} calculation can start reading RAM memories at any user selected address, and sequentially increment an address pointer for output generation. The parallel radix engine outputs are written back to the RAM, since the input data only needs to be read once. The contents of the RAM of the last stage processing can be raw input data from the previous stage, or final FFT outputs in sequential order, X(0), X(1), . . . X(N−1), or a combination of the two.

The time gap between OFDM symbols, which is reserved for cyclic prefix, allows the FFT output to be read out without being overwritten by new input data from the previous stage. Once the cyclic prefix is read out completely, the read pointer returns to the beginning of the first RAM to generate output X(0), X(1), and so on. At this point the RAMs are open to receive new data from the previous stage. Thus, system designers can choose where in the OFDM symbol to start generating outputs. A time-varying cyclic prefix can be accommodated without additional resources, which again translates to significant memory savings in dynamic OFDM systems

It will be appreciated that the invention is not restricted to the particular embodiment that has been described, and that variations may be made therein without departing from the scope of the invention as defined in the appended claims, as interpreted in accordance with principles of prevailing law, including the doctrine of equivalents or any other principle that enlarges the enforceable scope of a claim beyond its literal scope. Unless the context indicates otherwise, a reference in a claim to the number of instances of an element, be it a reference to one instance or more than one instance, requires at least the stated number of instances of the element but is not intended to exclude from the scope of the claim a structure or method having more instances of that element than stated. The word “comprise” or a derivative thereof, when used in a claim, is used in a nonexclusive sense that is not intended to exclude the presence of other elements or steps in a claimed structure or method.

1. A device capable of performing a stage of a Fast Fourier Transform (FFT) calculation, the device comprising:
a plurality of memory blocks, each memory block capable of storing an amount of data equal to the product of radix sizes of all previous stages;
a plurality of radix engines, the output of each radix engine fed back to a respective one of the plurality of memory blocks; wherein
each radix engine receives as an input data from each of the plurality of memory blocks.

2. The device of claim 1 including an additional radix engine whose output is not fed back into any memory block, where the additional radix engine receives as an input data from each of the plurality of memory blocks, as well as data not received from any of the plurality of memory blocks.

3. The device of claim 2 including a multiplexer that receives data from each of the plurality of memory blocks and the additional radix engine.

4. The device of claim 1 including a multiplexer that receives data from each of the plurality of memory blocks.

5. The device of claim 4 where the multiplexer receives data from an additional radix engine whose output is not fed back into any memory block, where the additional radix engine receives as an input data from each of the plurality of memory blocks, as well as data not received from any of the plurality of memory blocks.

6. The device of claim 1 operably connected to a plurality of other said devices, each performing different respective stages of the Fast Fourier Transform (FFT) calculation.

7. The device of claim 1 free from including shadow memory that, while data from the plurality of memory blocks is being output for calculation by the plurality of radix engines, receives new data for subsequent calculations.

8. The system of claim 1 capable of reading sequential memory blocks beginning from any user-selected address.

9. The system of claim 8 capable of writing a cyclic prefix that begins from the user-selected address without double buffering.

10. A method for calculating a stage of a Fast Fourier Transform (FFT) calculation, the method comprising:
storing initial data into a memory block, each memory block capable of storing an amount of data equal to the product of radix sizes of all previous stages;
reading the initial data from the memory block into a first radix engine, the output of the first radix engine comprising replacement data used to replace the initial data of the memory block;
reading the replacement data from the memory block to a multiplexer that forwards data to a next stage of the FFT calculation.

11. The method of claim 10 including forwarding the initial data to a second radix engine whose output is provided to the multiplexer.

12. The method of claim 11 including forwarding the replacement data to a third radix engine.
